(19) United States
(12) Patent Application Publication
(10) Pub. No.: US 2019/0062660 A1
(43) Pub. Date: Feb. 28, 2019

(54) CRUDE OIL COMPOSITION COMPRISING AN ADDITIVE FOR IMPROVING THE FLOW PROPERTIES OF PARAFFIN-CONTAINING CRUDE OIL

(71) Applicant: Universitaet Hamburg, Hamburg (DE)

(72) Inventors: Artem Uchaev, Klinci (RU); Alisa Gapchenko, Hamburg (DE); Hans-Ulrich Moritz, Bendestorf (DE); Werner Pauer, Ahrensburg (DE)

(21) Appl. No.: 16/093,999

(22) PCT Filed: Apr. 20, 2017
(86) PCT No.: PCT/EP2017/059408

§ 371 Date: Oct. 16, 2018

(30) Foreign Application Priority Data
Apr. 21, 2016 (DE) 10 2016 107 426.8
Apr. 21, 2016 (LU) 93040

(51) Int. Cl. C10L 10/16; C10L 1/196; C08F 212/08

(52) U.S. Cl. CPC C10L 10/16; C08F 220/06; C08F 212/08; C10L 1/1966

(57) ABSTRACT

An improvement of the flow properties of paraffin-containing crude oil, more specifically, a means of favourably influencing the pour point of crude oil and hence improving the flow properties of paraffin-containing crude oil. The crude oil composition is a paraffin-containing crude oil and has an amount of an additive that brings about lowering of the pour point of the crude oil, wherein the additive comprises at least one copolymer composed of at least two comonomers, and wherein all comonomers that make up the copolymer are selected from the groups (a) and (b) of comonomers, and wherein group (a) is comonomers formed from acrylic acid and methacrylic acid, and group (b) is comonomers formed from styrene and a styrene derivative.

The invention relates to a crude oil composition comprising an additive for improving the flow properties of paraffinic crude oil, a method for preparing a crude oil composition having a reduced pour point with respect to the crude oil, and the use of an additive for improving the flow properties of paraffinic crude oil.

Crude oil is a mixture of substances that consists mainly of hydrocarbons. In addition, crude oil contains oxygen and sulfur containing compounds such as naphthenic acids, phenol, aldehydes, thioesters and various heterocyclic compounds. A majority of the hydrocarbons is a mixture of straight-chain unbranched paraffins having 1 to 30 carbon atoms, wherein gaseous and solid hydrocarbons are dissolved in the liquid hydrocarbons.

At low temperatures, the paraffins in the crude oil cause particular problems in terms of flow properties. Paraffins begin to crystallize and agglomerate at temperatures around 40 to 50° C. in pure crude oil, which significantly impairs the flow properties of the crude oil. The temperature at which crude oil loses its flowing properties is called the pour point. This leads to deposits on the inner walls of the pipe in the transport of crude oil through pipe lines, especially in winter, in some cases even to complete blockage (for example, with temporary standstill of the crude oil in a pipeline).

There are mechanical, physical and chemical methods for restoring flowability, such as the following:

1) scraping the crystallized paraffins from the pipe inner wall by using a pig.
2) heating the crude oil to a temperature higher than the crystallization temperature of paraffins.
3) use of different solvents to dissolve heavy paraffins.

Chemical additives (so-called paraffin inhibitors) have been developed in recent years. Such additives are macromolecular substances which, by physical interaction with paraffins, modify their size, shape and adsorption properties. This leads to the formation of smaller paraffin crystals, which thereby no longer aggregate and no longer impair the flow properties of crude oil. Paraffin inhibitors predominantly have a structure similar to paraffin and generally have polar groups in the side chains. These branches have, among other things, the task of counteracting the crystal formation of the paraffins. The additives lead to a reduction of the pour point of crude oil.

Polymers, copolymers and terpolymers having an average molecular weight of 3,000 to 100,000 g/mol are known as paraffin inhibitors. The effectiveness of the additives depends on their chemical composition and their concentration.

U.S. Pat. No. 3,735,770 discloses a method for improving the flow properties of crude oils. This method comprises the addition of copolymers of ethylene with unsaturated carboxylic acid esters or of alkylphenols to the oil.

U.S. Pat. No. 3,393,057 discloses a terpolymer as a pour point depressant. This consists of 10 to 90% by weight of C₁₀-C₂₄ α-olefins, 2.5 to 35% by weight of butadiene and 2.5 to 35% by weight of styrene or indene, and at 210° F. has a kinematic viscosity of 35 to 600 centistokes.

U.S. Pat. No. 3,951,929 discloses a pour point improver which comprises an interpolymeric acrylic ester having an average molecular weight of 3,000 to 100,000.

EP 1 086 964 B2 discloses a pour point improver of (meth)acrylic acid copolymer. The poly(meth)acrylic acid ester copolymer consists of 5 to 60% by weight of (meth)acrylic acid esters of alcohols having 11 to 15 carbon atoms, and 95 to 40% by weight of (meth)acrylic acid esters of alcohols having 16 to 30 C atoms.

DE 2048308 A1 discloses, as a paraffin inhibitor, a mixture of ethylene-vinyl ester copolymer having a molecular weight of 3,000 and 9,000. 0.01% to 0.5% by weight of the mixture is added to the crude oil to reduce the pour point.

EA 012243 B1 discloses a pour point improver that consists of a product of polyoxyethylene sorbitan ester condensation with carboxylic acid anhydrides. The additive improves the depressive properties, flow and viscosity of petroleum and petroleum products. The optimum result is achieved with the addition of 50 to 5,000 ppm.

WO 2001/096503 A2 discloses an additive for improving the flowability of mineral oil. This contains: a) copolymers of 80 to 96.5 mol % of ethylene and 3.5 to 20 mol % vinyl esters of carboxylic acids having 1 to 20 C atoms and/or (meth)acrylic acid esters of alcohols having 1 to 8 C atoms, and homopolymers or copolymers of C₁₀-C₃₀ alkyl radicals carrying esters of ethylenically unsaturated carboxylic acids with up to 20 mol % of olefinically unsaturated compounds, b) a poly-α-olefin having a molecular weight of 250 to 5,000, which is derived from monoolefins having 3 to 5 carbon atoms, and c) an organic acid selected from certain alkylphenol-aldehyde resins and aliphatic and/or aromatic sulfonic acids.

U.S. Pat. No. 7,790,821 B2 discloses a method for producing a stable latex dispersion consisting of (co)polymers with one or more (meth)acrylic acid ester monomers of alcohols having 6 to 40 carbon atoms, optionally with one or more monomers, of the not very water-soluble (meth)acrylic and/or vinyl type, and optionally one or more polar monomers selected from (meth)acrylamides and their derivatives, and optionally one or more monomers selected from ethylenically unsaturated mono- and/or dicarboxylic acids or their anhydrides. The latex dispersion inhibits the separation of paraffins in the crude oil.

EP 0 120 512 A2 discloses a pour point improver comprising a small amount of a polymer having mainly aliphatic hydrocarbon side chains having at least 14 carbon atoms, wherein the polymer has a branched carbon backbone.

EP 0 332 000 A2 discloses the use of copolymers of acrylic and/or methacrylic acid esters of higher alcohols or alcohol cuts having at least 16 C atoms in the alcohol radical and not more than 5% by weight of maleic anhydride as a flow improver in paraffin-rich crude oils and/or petroleum fractions with intrinsic flow points above 25° C. for lowering their pour points to values below 15° C.

U.S. Pat. No. 4,284,414 discloses mixed alkyl esters as flow improvers for crude oil, which flow improvers are prepared by reacting a mixture of two or more specific monohydric alcohols with interpolymers which are derived from (i) α, β unsaturated dicarboxylic acids or derivatives thereof, and (ii) vinylaromatic monomers having up to 12 carbon atoms.

There is still a need to improve the flow properties of crude oil.

The object of the present invention is therefore to provide a way to favorably influence the pour point of crude oil and thus to improve the flow properties of crude oil.

In a first aspect, the invention provides a crude oil composition comprising a paraffinic crude oil and an amount of an additive which causes a reduction of the pour point of the crude oil, wherein the additive comprises at least one copolymer that is composed of at least two comonomers, wherein all comonomers composing the copolymer are selected from the groups (a) and (b) of comonomers, and wherein the group (a) of comonomers consists of acrylic acid and methacrylic acid, and the group (b) of comonomers consists of styrene and a styrene derivative.

It has surprisingly been found that the use of a copolymer of at least two comonomers, wherein the comonomers are selected from the groups (a), consisting of acrylic acid and methacrylic acid, and (b), consisting of styrene and a styrene derivative, can improve the cold properties of crude oil. Examples of corresponding copolymers are acrylic acid/styrene, methacrylic acid/styrene or (meth)acrylic acid/styrene derivative, or else mixed polymers of a mixture of acrylic acid and methacrylic acid and styrene or styrene derivative.

“Paraffinic crude oil” is understood to mean a crude oil (crude petroleum) that contains hydrocarbons in the form of paraffins. “Paraffins” is understood here to mean acyclic, saturated, straight-chain or branched hydrocarbons (alkanes) having 1 to 33 carbon atoms, in particular having 12 to 33 carbon atoms or 16 to 20 carbon atoms. “Paraffin-containing crude oil” is used here in particular when the paraffin content is at least 10%.

The term “acrylic acid” (propenoic acid, CAS number 79-10-7) is understood to mean a compound of the formula CH₂═CH—COOH.

The term “methacrylic acid” (2-methylpropenoic acid, CAS number 79-41-4) is understood to mean a compound of the formula CH₂═C(CH₃)—COOH.

The term “styrene” (phenylethene, CAS number 100-42-5) is understood to mean a compound of the following formula:

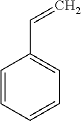

The term “styrene derivative” is understood here to mean a compound according to the following formula:

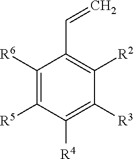

wherein R², R³, R⁴, R⁵ and R⁶ are each independently of one another H, or alkyl, preferably H, methyl, or C₂-C₁₂ alkyl, with the proviso that not all radicals R² to R⁶ are H. An example of a styrene derivative is 4-methylstyrene (R⁴═CH₃; R², R³, R⁵ and R⁶═H). A compound in which all R² to R⁶ are H would correspond to styrene.

The formulation according to which the comonomers of the at least one copolymer “are selected from the groups (a) and (b) of comonomers, wherein the group (a) of comonomers consists of acrylic acid and methacrylic acid and the group (b) of comonomers consists of styrene and a styrene derivative” or the formulation according to which the at least one copolymer “is composed of at least two comonomers, wherein all the comonomers composing the copolymer are selected from the groups (a) and (b) of comonomers, wherein the group (a) of comonomers consists of acrylic acid and methacrylic acid, and the group (b) of comonomers consists of styrene and a styrene derivative”, means that the copolymer is in any case composed of at least one type of comonomer from the group (a) and at least one type of comonomer from the group (b). Examples of copolymers would therefore be those of two comonomers, for example, the comonomers acrylic acid (group a) and styrene (group b), acrylic acid (group a) and styrene derivative (group b), methacrylic acid (group a) and styrene (group b) or methacrylic acid (group a) and styrene derivative (group b).

However, these also include copolymers of more than two comonomers, for example, those of acrylic acid, methacrylic acid (group a) and styrene (group b), acrylic acid, methacrylic acid (group a), styrene and styrene derivative (group b), acrylic acid (group a), styrene and styrene derivative (group b), or methacrylic acid (group a), styrene and styrene derivative (group b). In principle, mixed polymers of more than four comonomers are also suitable, for example, a copolymer of acrylic acid, methacrylic acid (group a), styrene, styrene derivative 1 and styrene derivative 2 (group b). Preferred are copolymers of acrylic acid and styrene or methacrylic acid and styrene.

The formulation according to which “the additive comprises at least one copolymer of at least two comonomers” or “the additive comprises at least one copolymer that is composed of at least two comonomers” includes, besides additives, a copolymer having a substantially uniform comonomer composition, that is, a copolymer of two particular comonomers (for example, acrylic acid and styrene), also mixtures of copolymers having different comonomer composition, provided that the copolymers of the copolymer mixture have the composition specified above, that is, are composed of at least two comonomers that are selected from comonomers of the groups a and b. The copolymer mixture may contain, for example, copolymers of acrylic acid and styrene, methacrylic acid and styrene and/or acrylic acid, methacrylic acid and styrene.

The formulation “improving the flow properties of paraffinic crude oil” is understood here to mean a reduction of the pour point of the crude oil. The pour point is the temperature at which crude oil loses its flowing properties. The pour point can be determined, for example, according to ASTM D5853. A crude oil composition containing the additive according to the invention thus has a lower pour point compared to crude oil. For example, a crude oil may have a pour point of 12° C., while the crude oil composition has a pour point of −5° C.

The term “pour point improver”, “pour point depressant” or “paraffin inhibitor” is understood here to mean an additive which reduces the pour point of a crude oil, preferably by at least 1° C., more preferably by at least 2° C., at least 3° C., at least 4° C., at least 5° C., at least 6° C., at least 7° C., at least 8° C., at least 9° C. or at least 10° C.

The term “alkyl” includes saturated and unsaturated aliphatic (non-aromatic) groups, including straight-chain alkyl groups (for example, methyl, ethyl, propyl, butyl, pentyl, hexyl, heptyl, and octyl) and branched chain alkyl groups (for example, isopropyl, tert-butyl, isobutyl). The term “C₂-C₁₂ alkyl” means an alkyl group having 2, 3, 4, 5, 6, 7, 8, 9, 10, 11 or 12 C atoms.

If a molecular weight is specified here in relation to a copolymer used according to the invention, this means the weight-average molecular weight (unit g/mol).

Range specifications such as “10,000 to 30,000” are always to be understood here to mean that each intermediate value is also disclosed. An arbitrary smaller range of the range is also to be disclosed here, wherein also ranges which do not include any of the limit values of the range are understood to mean smaller ranges. For example, a specification such as “10,000 to 30,000” includes not only ranges such as “10,000 to 29,000” or “15,000 to 30,000” but also ranges of “15,000 to 28,000” or “20,000 to 29,000” or “12,000 to 27,000”, wherein the individual values within the range are expressly included, not just its limits.

A copolymer used according to the invention has the general structure according to the following formula I:

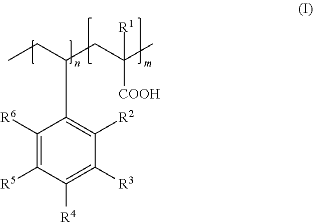

wherein R¹ is H or methyl, R², R³, R⁴, R⁵ and R⁶ are each independently of each other H, or alkyl, preferably H, methyl, or C₂-C₁₂ alkyl, and m is the number of the comonomer(s) of the group (a) (acrylic acid, methacrylic acid) and n indicates the number of comonomer(s) of the group (b) (styrene, styrene derivative) in the copolymer. The above formula indicates schematically only a general structure and is in particular not to be understood to mean that this must be an alternating copolymer or block copolymer. Rather, it may also be a random copolymer. As already stated, the formula is also not to be understood that only two comonomers, for example, acrylic acid and styrene, are present in the copolymer. Rather, mixtures of more than two comonomers are suitable (for example, acrylic acid, methacrylic acid and styrene), but with the proviso that always at least one comonomer from group a and at least one comonomer from group b is present.

The preparation of copolymers is basically known (see, for example, Ullmanns Enzyklopädie der Technischen Chemie, Vol. 21, pages 305 to 403). In this case, monomers are dissolved in an organic solvent and polymerized in the presence of a radical initiator at temperatures in the range of, for example, 30 to 150° C.

In a preferred embodiment of the crude oil composition according to the invention, the additive comprises 0.05 to 50% by weight, preferably 0.5 to 50% by weight, 1 to 50% by weight, 2.5 to 50% by weight or 5 to 50% by weight, more preferably 5 to 45% by weight, 10 to 45% by weight, 15 to 45% by weight or 15 to 40% by weight, particularly preferably 20 to 40% by weight of the at least one copolymer.

In a preferred embodiment, the at least one copolymer used in the additive is composed of two comonomers, wherein the comonomer from the group (a) of comonomers is acrylic acid or methacrylic acid, preferably acrylic acid, and the comonomer from the group (b) of comonomers is styrene or a styrene derivative, preferably styrene.

The molecular weight or molecular weight distributions (MWD) of the copolymers used according to the invention in the crude oil composition can be in a range from 2,000 to 500,000 g/mol, preferably from 5,000 to 300,000 g/mol. The molecular weight distribution can be determined, for example, by means of gel permeation chromatography against polystyrene standards. For example, the conversion of acrylic acid can be determined after the reaction by reverse phase high performance liquid chromatography (RP-HPLC). For example, H₂O/K₂HPO₄ (pH=−2.7) can be used as a buffer and acetonitrile can be used as an eluent. The conversions of styrene can be determined, for example, after the reaction by means of gas chromatography (GC).

The average molecular weight or molecular weight distribution of the copolymer or copolymer mixture in the additive is preferably adjusted to the crude oil used to prepare the crude oil composition according to the invention, in particular the molecular weight distribution of the paraffins contained therein. In a preferred embodiment of the crude oil composition according to the invention, the at least one copolymer has an average molecular weight of 2,000 to 30,000 g/mol, preferably 5,000 to 30,000 g/mol, more preferably 10,000 to 30,000 g/mol, 10,000 to <30,000 g/mol, 10,000 to 29,000 g/mol, 10,000 to 28,000 g/mol, 10,000 to 27,000 g/mol, 10,000 to 26,000 g/mol or 10,000 to 25,000 g/mol.

In a further preferred embodiment of the crude oil composition according to the invention, in the additive, the proportion of the comonomer (a) in the at least one copolymer, based on the comonomer mixture, is 0.6 to <10.0% by weight, preferably 1.0 to <10.0% by weight, more preferably 1.0 to 9.0% by weight, 2.0 to 9.0% by weight, 3.0 to 9.0% by weight, 4.0 to 9.0% by weight, 5.0 to 9.0% by weight or 5.0 to 8.0% by weight.

In a particularly preferred embodiment of the crude oil composition according to the invention, in the additive, the at least one copolymer has an average molecular weight of 10,000 to 30,000 g/mol, and a proportion of acrylic acid of 1.0 to <10.0% by weight, preferably from 2.0 to 9.0% by weight, more preferably 3.0 to 9.0% by weight, 4.0 to 9.0% by weight, 5.0 to 9.0% by weight or 5.0 to 8.0% by weight, for example, 5% by weight.

The additive preferably also comprises at least one organic solvent in addition to the at least one copolymer, wherein the organic solvent is preferably an aromatic solvent, and is more preferably selected from aromatic hydrocarbons such as toluene, xylene, trimethylbenzene, ethylbenzene, dimethylnaphthalene or a mixture thereof. The organic solvent is preferably chosen so that it is readily soluble in crude oil and simultaneously dissolves the copolymer or copolymer mixture according to the invention well. The additive may be composed of the at least one copolymer and the at least one organic solvent. The proportion of the solvent in the additive for this case, depending on the proportion of the at least one copolymer, is, for example 50 to 99.95% by weight, 50 to 99.5% by weight, 50 to 97.5% by weight, 50 to 95% by weight, 55 to 95% by weight, 55 to 90% by weight, 55 to 85% by weight, 60 to 85% by weight or 60 to 80% by weight. For example, the additive may be composed of 20% by weight of the at least one copolymer and 80% by weight of the at least one solvent.

For the preparation of a copolymer, for example, azo-bis-isobutyronitrile, esters of peroxycarboxylic acid such as t-butyl perprivalate and t-butyl-per-2-ethylxeanoate or dibenzoyl peroxide or other peroxides and azo compounds can be used as radical initiators. At higher temperatures (for example, above 80° C.), the thermal initiation of the polymerization can also be triggered by reactions of the styrene. The initiators can be added to the comonomer mixture, for example, in an amount of 0.05 to 10% by weight. The desired properties of the copolymer can be adjusted, for example, by varying the reaction parameters pressure and temperature and by the ratio of initiator to monomer(s).

A preferred crude oil composition according to the invention comprises an amount of the additive which causes a pour point reduction of the crude oil of at least 1° C., preferably at least 2° C., at least 3° C., at least 4° C., at least 5° C., at least 6° C., at least 7° C., at least 8° C., at least 9° C. or at least 10° C.

In a further preferred embodiment, the crude oil composition according to the invention comprises, for example, 1 to 1000 ppmw, preferably 5 to 1000 ppmw or 5 to 750 ppmw, particularly preferably 5 to 500 ppmw, 10 to 500 ppmw, 10 to 300 ppmw or 15 to 250 ppmw of the at least one copolymer.

In a further aspect, the present invention also relates to a method for preparing a crude oil composition having a reduced pour point with respect to crude oil, comprising adding an additive to the crude oil in an amount which causes a reduction of the pour point, wherein the additive comprises at least one copolymer which is composed of at least two comonomers, wherein all comonomers composing the copolymer are selected from the groups (a) and (b) of comonomers, and wherein the group (a) of comonomers consists of acrylic acid and methacrylic acid, and the group (b) of comonomers consists of styrene and a styrene derivative.

Preferably, an additive is added to the crude oil, which additive comprises 0.05 to 50% by weight, preferably 0.5 to 50% by weight, 1 to 50% by weight, 2.5 to 50% by weight or 5 to 50% by weight, more preferably 5 to 45% by weight, 10 to 45% by weight, 15 to 45% by weight or 15 to 40% by weight, particularly preferably 20 to 40% by weight of the at least one copolymer.

In a preferred embodiment of the method according to the invention, an additive is added to the crude oil,

a. in which the at least one copolymer has a weight-average molecular weight of 2,000 to 30,000 g/mol, preferably 5,000 to 30,000 g/mol, more preferably 10,000 to <30,000 g/mol, 10,000 to 30,000 g/mol, 10,000 to 29,000 g/mol, 10,000 to 28,000 g/mol, 10,000 to 27,000 g/mol, 10,000 to 26,000 g/mol or 10,000 to 25,000 g/mol or 10,000 to 25,000 g/mol, and/or
b. in which the proportion of the comonomers of the group (a) in the at least one copolymer, based on the comonomer mixture, is 0.6 to <10.0% by weight, preferably 1.0 to <10.0% by weight, further preferably 1.0 to 9.0% by weight, 2.0 to 9.0% by weight, 3.0 to 9.0% by weight, 4.0 to 9.0% by weight, 5.0 to 9.0% by weight or 5.0 to 8.0% by weight, and/or
c. in which the at least one copolymer is composed of two comonomers, and wherein the comonomer from the group (a) of comonomers is acrylic acid or methacrylic acid, preferably acrylic acid, and the comonomer from the group (b) of comonomers is styrene or a styrene derivative, preferably styrene, and/or
d. which further comprises at least one organic solvent, wherein the organic solvent is preferably an aromatic solvent, more preferably is an aromatic hydrocarbon, and is more preferably selected from toluene, xylene, trimethylbenzene, ethylbenzene, dimethylnaphthalene or a mixture thereof.

In a further preferred embodiment of the method according to the invention, an amount of the additive is added to the crude oil, which additive causes a reduction of the pour point by at least 1° C., preferably at least 2° C., at least 3° C., at least 4° C., at least 5° C., at least 6° C., at least 7° C., at least 8° C., at least 9° C. or at least 10° C.

In a further preferred embodiment of the method according to the invention, an amount of the additive is added to the crude oil such that the resulting crude oil composition contains 1 to 1,000 ppmw, preferably 5 to 1,000 ppmw or 5 to 750 ppmw, particularly preferably 5 to 500 ppmw, 10 to 500 ppmw, 10 to 300 ppmw or 15 to 250 ppmw of the at least one copolymer.

In a still further aspect, the present invention relates to the use of a copolymer or mixture of copolymers composed of at least two comonomers, wherein all comonomers of the copolymer or copolymer mixture are selected from the groups (a) and (b) of comonomers, and wherein the group (a) of comonomers consists of acrylic acid and methacrylic acid, and the group (b) of comonomers consists of styrene or a styrene derivative, as an additive for improving the flow properties of paraffinic crude oil.

In particular, the invention according to this aspect relates to the use of the additive for the reduction of the pour point of paraffinic crude oil, preferably by at least 1° C., preferably at least 2° C., at least 3° C., at least 4° C., at least 5° C., at least 6° C., at least 7° C., at least 8° C., at least 9° C. or at least 10° C.

In a preferred embodiment, a copolymer or copolymer mixture is used which is present dissolved in an organic solvent, wherein the copolymer or copolymer mixture amounts to 0.05 to 50% by weight, preferably 0.5 to 50% by weight, 1 to 50% by weight, 2.5 to 50% by weight or 5 to 50% by weight, more preferably 5 to 45% by weight, 10 to 45% by weight, 15 to 45% by weight or 15 to 40% by weight, particularly preferably 20 to 40% by weight of the solution of copolymer or copolymer mixture and organic solvent.

The copolymer or copolymer mixture is preferably present in an aromatic solvent, preferably in a solvent of one or more aromatic hydrocarbons, for example toluene, xylene, trimethylbenzene, ethylbenzene, dimethylnaphthalene or a mixture thereof.

The invention will be described in more detail below for the purpose of illustration by way of example only.

Preparation of an additive for improving the flow properties of paraffinic crude oil.

With stirring, a mixture of acrylic acid, styrene (or a styrene derivative) and hydrocarbon solvent was heated at a temperature of 95° C. with N₂ flow. The amount of the comonomer mixture in the formulation was 20.0 to 40.0% by weight.

The amount of acrylic acid was 0.6 to 10.0% by weight, based on the comonomer mixture. Thereafter, initiator (dibenzoyl peroxide) was used in an amount of 0.1 to 3.0% by weight, based on the comonomer mixture. The dosing of the initiator took place at intervals of 40 minutes (4 to 6 times) (ratio of initiator to monomers: 0.1 to 3.0% by weight) to full conversion after about 160 to 240 minutes.

Solubility of copolymers having different acrylic acid content.

It has been investigated how different acrylic acid components in the copolymer affect its solubility in hydrocarbons. A diesel fraction was used for the studies since the solubility/insolubility can be readily observed with the naked eye. The result is reproduced in Tab. 1.

TABLE 1
Influence of the amount of acrylic acid in the formulation on the
solubility of the copolymer in hydrocarbons (diesel fraction).

| | Amount of acrylic acid in the formulation | | | | | | |
|---|---|---|---|---|---|---|---|
| | based on the comonomer mixture [Wt. %] | | | | | | |
| | 0.0 | 2.0 | 3.0 | 5.0 | 7.0 | 9.0 | 10.0 |
| Soluble (Yes/No) | Yes | Yes | Yes | Yes | Yes | Yes | No |

Copolymers that are prepared with 10% or more by weight of acrylic acid did not dissolve in hydrocarbons.

The effectiveness of the prepared copolymers as paraffin inhibitor (pour point depressants) was determined by measuring the pour point, determined according to ASTM D5853. The “Sahara” (“Saharan Blend”) crude oil variety was used with a pour point of +12.0° C. (see Tab. 2).

TABLE 2
Influence of the amount of acrylic acid in the formulation on the pour
point of the variety of “Sahara” crude oil.

| Amount of acrylic acid, | | |
|---|---|---|
| based on the comonomer mixture | Concentration | |
| (Dibenzoyl peroxide 2.0% by weight) | of the copolymer | Pour point |
| [Wt. %] | [ppmw] | [° C.] |
| 0.0 | 150 | +10.0 |
| 2.0 | 150 | +7.0 |
| 4.0 | 150 | −2.0 |
| 5.0 | 150 | −12.0 |
| 7.0 | 150 | +1.0 |
| 10.0 | 150 | +12.0 |

Examples for the preparation of paraffin inhibitors comprising copolymers of styrene/acrylic acid (S/AA) having different molecular weight (acrylic acid content in each case 5% by weight) are described in the following:

### EXAMPLE 1

1.50 g of acrylic acid (acrylic acid 5.0% by weight of the comonomer mixture), 28.50 g of styrene and 69.85 g of toluene were placed under an exhaust hood (protective gas stream) in a 500 ml beaker. After gassing with inert gas (for example, N₂ or argon) for ½ hour at room temperature (25° C.), the mixture was heated to a temperature of 95° C. with constant stirring (300 rpm). Over a period of 320 minutes, a total of 0.075 g of dibenzoyl peroxide (dibenzoyl peroxide 0.25% by weight of the comonomer mixture) was added to the mixture at the same temperature. The addition was carried out with a dosage of 5×0.015 g of dibenzoyl peroxide at intervals of about 40 minutes each until the full conversion was reached. After the last addition of dibenzoyl peroxide, stirring was continued for 2 hours and 40 minutes. The resulting copolymer had a weight-average molecular weight of 30,040 g/mol.

### EXAMPLE 2

1.50 g of acrylic acid (acrylic acid 5.0% by weight of the comonomer mixture), 28.50 g of styrene and 69.85 g of toluene were placed under an exhaust hood (protective gas stream) in a 500 ml beaker. After gassing with inert gas for hour at room temperature (25° C.), the mixture was heated to a temperature of 95° C. with constant stirring (300 rpm). Over a period of 320 minutes, a total of 0.15 g of dibenzoyl peroxide (dibenzoyl peroxide 0.50% by weight of the comonomer mixture) was added to the mixture at the same temperature. The addition was carried out with a dosage of 5×0.03 g of dibenzoyl peroxide at intervals of about 40 minutes each until the full conversion was reached. After the last addition of dibenzoyl peroxide, stirring was continued for 2 hours and 40 minutes. The resulting copolymer had a weight-average molecular weight of 21,750 g/mol.

### EXAMPLE 3

1.50 g of acrylic acid (acrylic acid 5.0% by weight of the comonomer mixture), 28.50 g of styrene and 69.85 g of toluene were placed under an exhaust hood (protective gas stream) in a 500 ml beaker. After gassing with inert gas for hour at room temperature (25° C.), the mixture was heated to a temperature of 95° C. with constant stirring (300 rpm). Over a period of 320 minutes, a total of 0.30 g of dibenzoyl peroxide (dibenzoyl peroxide 1.00% by weight of the comonomer mixture) was added to the mixture at the same temperature. The addition was carried out with a dosage of 5×0.06 g of dibenzoyl peroxide at intervals of about 40 minutes each until the full conversion was reached. After the last addition of dibenzoyl peroxide, stirring was continued for 2 hours and 40 minutes. The resulting copolymer had a weight-average molecular weight of 17,990 g/mol.

### EXAMPLES 4, 5

Two further paraffin inhibitors were prepared according to the pattern described in Examples 1-3, wherein the amount of dibenzoyl peroxide was 2.0 or 2.5% by weight, respectively. The copolymers produced had weight-average molecular weights of 11,580 g/mol or 10,510 g/mol, respectively.

The additives prepared in Examples 1-5 were added to the variety of “Sahara” crude oil and the pour point of the crude oil compositions according to the invention thus prepared was determined (see Tab. 4).

TABLE 3
Influence of the molecular weight of the copolymer on the pour point
of the variety “Sahara” crude oil.

| | Amount of dibenzoyl | | | |
|---|---|---|---|---|
| | peroxide based | | | |
| | on the | | | |
| | comonomer mixture | | Concentration | |
| | (Acrylic acid | | of the | |
| Example | 5.0% by weight) | Mw | copolymer | Pour point |
| No. | [Wt. %] | [g/mol] | [ppmw] | [° C.] |
| Ex. 1 | 0.25 | 30.040 | 150 | +12.0 |
| Ex. 2 | 0.5 | 21.750 | 150 | −20.0 |
| Ex. 3 | 1.0 | 17.990 | 150 | −21.0 |
| Ex. 4 | 2.0 | 11.580 | 150 | −12.0 |
| Ex. 5 | 2.5 | 10.510 | 150 | −10.0 |

The additive prepared in Example 3 was added in different concentrations to the varieties “Sibir” (pour point +17.0° C.) and “Sahara” (pour point +12.0° C.) crude oils and the pour point of the resulting crude oil compositions was determined (see Tab. 4, 5).

TABLE 4
Cold properties of the variety “Sibir” crude oil using 50 to 500 ppm
of copolymer S/AA

| | Concentration of the copolymer | Pour point |
|---|---|---|
| Example No. | [ppmw] | [° C.] |
| Ex. 3 | 15 | +15.0 |
| Ex. 3 | 22.5 | −4.0 |
| Ex. 3 | 30 | −21.0 |
| Ex. 3 | 60 | −21.0 |
| Ex. 3 | 150 | −21.0 |

TABLE 5
Cold properties of the variety “Sibir” crude oil using 50 to 500 ppm
of copolymer S/AA

| | Concentration of the copolymers | Pour point |
|---|---|---|
| Example No. | [ppmw] | [° C.] |
| Ex. 3 | 15 | +12.0 |
| Ex. 3 | 30 | −10.0 |
| Ex. 3 | 75 | −20.0 |
| Ex. 3 | 150 | −21.0 |
| Ex. 3 | 225 | −21.0 |

1. A crude oil composition, comprising a paraffinic crude oil and an amount of an additive which causes a reduction of the pour point of the crude oil, wherein the additive comprises at least one copolymer that is composed of at least two comonomers, wherein all comonomers composing the copolymer are selected from the groups (a) and (b) of comonomers, and wherein the group (a) of comonomers consists of acrylic acid and methacrylic acid, and the group (b) of comonomers consists of styrene and a styrene derivative.

2. The crude oil composition according to claim 1, wherein the additive comprises 0.05 to 50% by weight, preferably 0.5 to 50% by weight, 1 to 50% by weight, 2.5 to 50% by weight or 5 to 50% by weight, more preferably 5 to 45% by weight, 10 to 45% by weight, 15 to 45% by weight or 15 to 40% by weight, particularly preferably 20 to 40% by weight of the at least one copolymer.

3. The crude oil composition according to claim 1, wherein the at least one copolymer has a weight-average molecular weight of 2,000 to 30,000 g/mol, preferably 5,000 to 30,000 g/mol, more preferably 10,000 to <30,000 g/mol, 10,000 to 30,000 g/mol, 10,000 to 29,000 g/mol, 10,000 to 28,000 g/mol, 10,000 to 27,000 g/mol, 10,000 to 26,000 g/mol or 10,000 to 25,000 g/mol or 10,000 to 25,000 g/mol.

4. The crude oil composition according to claim 1, wherein the proportion of the comonomers of the group (a) to the at least one copolymer, based on the comonomer mixture, is 0.6 to <10.0% by weight, preferably 1.0 to <10.0% by weight, more preferably 1.0 to 9.0% by weight, 2.0 to 9.0% by weight, 3.0 to 9.0% by weight, 4.0 to 9.0% by weight, 5.0 to 9.0% by weight or 5.0 to 8.0% by weight.

5. The crude oil composition according to claim 1, wherein the at least one copolymer is composed of two comonomers, and wherein the comonomer from the group (a) of comonomers is acrylic acid or methacrylic acid, preferably acrylic acid, and the comonomer from the group (b) of comonomers is styrene or a styrene derivative, preferably styrene.

6. The crude oil composition according to claim 1, wherein the additive further comprises at least one organic solvent, and wherein the organic solvent is preferably an aromatic solvent, more preferably an aromatic hydrocarbon, and is more preferably selected from toluene, xylene, trimethylbenzene, ethylbenzene, dimethylnaphthalene or a mixture thereof.

7. The crude oil composition according to claim 1, comprising an amount of the additive which causes a reduction of the pour point of the crude oil, determined according to ASTM D5853, of at least 1° C., preferably at least 2° C., at least 3° C., at least 4° C., at least 5° C., at least 6° C., at least 7° C., at least 8° C., at least 9° C. or at least 10° C.

8. The crude oil composition according to claim 1, comprising 1 to 1000 ppmw, preferably 5 to 1000 ppmw or 5 to 750 ppmw, particularly preferably 5 to 500 ppmw, 10 to 500 ppmw, 10 to 300 ppmw or 15 to 250 ppmw of the at least one copolymer.

9. A method for preparing a crude oil composition having a reduced pour point with respect to crude oil, comprising adding an additive to the crude oil in an amount which causes a reduction of the pour point, wherein the additive comprises at least one copolymer, which copolymer is composed of at least two comonomers, wherein all comonomers composing the copolymer are selected from the groups (a) and (b) of comonomers, and wherein the group (a) of comonomers consists of acrylic acid and methacrylic acid, and the group (b) of comonomers consists of styrene and a styrene derivative.

10. The method according to claim 9, wherein an additive is added to the crude oil, which comprises 0.05 to 50% by weight, preferably 0.5 to 50% by weight, 1 to 50% by weight, 2.5 to 50% by weight or 5 up to 50% by weight, more preferably 5 to 45% by weight, 10 to 45% by weight, 15 to 45% by weight or 15 to 40% by weight, particularly preferably 20 to 40% by weight of the at least one copolymer.

11. The method according to claim 9, wherein an additive is added to the crude oil,
a. in which the at least one copolymer has a weight-average molecular weight of 2,000 to 30,000 g/mol, preferably 5,000 to 30,000 g/mol, more preferably 10,000 to <30,000 g/mol, 10,000 to 30,000 g/mol, 10,000 to 29,000 g/mol, 10,000 to 28,000 g/mol, 10,000 to 27,000 g/mol, 10,000 to 26,000 g/mol or 10,000 to 25,000 g/mol or 10,000 to 25,000 g/mol, and/or
b. in which the proportion of the comonomers of the group (a) in the at least one copolymer, based on the comonomer mixture, is 0.6 to <10.0% by weight, preferably 1.0 to <10.0% by weight, further preferably 1.0 to 9.0% by weight, 2.0 to 9.0% by weight, 3.0 to 9.0% by weight, 4.0 to 9.0% by weight, 5.0 to 9.0% by weight or 5.0 to 8.0% by weight, and/or
c. in which the at least one copolymer is composed of two comonomers, and wherein the comonomer from the group (a) of comonomers is acrylic acid or methacrylic acid, preferably acrylic acid, and the comonomer from the group (b) of comonomers is styrene or a styrene derivative, preferably styrene, and/or
d. which further comprises at least one organic solvent, wherein the organic solvent is preferably an aromatic solvent, more preferably is an aromatic hydrocarbon, and is more preferably selected from toluene, xylene, trimethylbenzene, ethylbenzene, dimethylnaphthalene or a mixture thereof.

12. The method according to claim 9, wherein an amount of the additive is added to the crude oil which causes a reduction of the pour point as determined according to ASTM D5853 by at least 1° C., preferably at least 2° C., at least 3° C., at least 4° C., at least 5° C., at least 6° C., at least 7° C., at least 8° C., at least 9° C. or at least 10° C.

13. The method according to claim 9, wherein an amount of the additive is added to the crude oil such that the crude oil composition contains 1 to 1000 ppmw, preferably 5 to 1000 ppmw or 5 to 750 ppmw, more preferably 5 to 500 ppmw, 10 to 500 ppmw, 10 to 300 ppmw or 15 to 250 ppmw of the at least one copolymer.

14. An additive for improving the flow properties of paraffinic crude oil, the additive comprising a copolymer or mixture of copolymers composed of at least two comonomers, wherein all comonomers of the copolymer or copolymer mixture are selected from the groups (a) and (b) of comonomers, and wherein the group (a) of comonomers consists of acrylic acid and methacrylic acid, and the group (b) of comonomers consists of styrene or a styrene derivative.

15. The additive according to claim 15 for reducing the pour point of paraffinic crude oil, preferably at least 1° C., preferably at least 2° C., at least 3° C., at least 4° C., at least 5° C., at least 6° C., at least 7° C., at least 8° C., at least 9° C. or at least 10° C.

16. The additive according to claim 15, wherein the copolymer or copolymer mixture is present dissolved in an organic solvent, and wherein the copolymer or copolymer mixture amounts to 0.05 to 50% by weight, preferably 0.5 to 50% by weight, 1 to 50% by weight, 2.5 to 50% by weight or 5 to 50% by weight, more preferably 5 to 45% by weight, 10 to 45% by weight, 15 to 45% by weight or 15 to 40% by weight, more preferably 20 to 40% by weight of the solution of copolymer or copolymer mixture and organic solvent.

17. The additive according to claim 16, wherein the copolymer or copolymer mixture is present in an aromatic solvent, preferably in an aromatic solvent selected from toluene, xylene, trimethylbenzene, ethylbenzene, dimethylnaphthalene, or a mixture thereof.
